(19) United States
(12) Patent Application Publication
(10) Pub. No.: US 2021/0312377 A1
(43) Pub. Date: Oct. 7, 2021

(54) CAPACITY OPTIMIZED AND BALANCED FILL LEVELS

(71) Applicant: SAP SE, Walldorf (DE)

(72) Inventors: Barbara Wessela, Saarbrucken (DE); Roland Martin, Waldi (DE); Arshad Ansary, Bangalore (IN)

(21) Appl. No.: 16/877,809

(22) Filed: May 19, 2020

(30) Foreign Application Priority Data
Apr. 7, 2020 (IN) 202011015266

(51) Int. Cl. G06Q 10/08; G06N 20/00; G06Q 10/04; G06Q 30/02; G06Q 30/06

(52) U.S. Cl. CPC G06Q 10/087; G06N 20/00; G06Q 30/0635; G06Q 30/0202; G06Q 10/04

(57) ABSTRACT

Provided is a system and method for the optimized allocation of partial quantities of an item to a plurality of locations. The optimization process can balance multiple factors across multiple locations at the same time including predicted demands and available storage areas thereby ensuring that different locations have a same appearance. In one example, the method may include storing predicted demand values for an object and available storage area values for the object from a plurality of users, respectively, receiving a quantity of the object to be distributed among the plurality of users, determining partial quantities of the object to be distributed among the plurality of users based on the predictive demand values for the object and available storage area values for the object among the plurality of users, and outputting the determined partial quantities of the object for display.

### BACKGROUND

Optimal use of space is essential for businesses that routinely replace items for sale with new ones. Deciding how much space to devote to a particular product, such as a promotional item, can be difficult. Also, some stores have more space than others. Therefore, different stores may allocate different areas/capacities for selling a product. Furthermore, when a distributor must allocate a quantity of product across multiple stores, determining how much product to allocate to each individual store can be a challenge. For example, demand is not always the same from store to store. Furthermore, available space is not always the same from store to store. In this case, allocating the same quantity to each store will result in too little product being allocated to some stores and too much product allocated to other stores.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a computing environment for allocating a quantity of an item in accordance with an example embodiment.

FIG. 2A is a diagram illustrating a user interface for modeling available capacity in accordance with an example embodiment.

FIG. 2B is a diagram illustrating a process of predicting demand in accordance with an example embodiment.

FIG. 3A is a diagram illustrating a process of determining partial quantities of an item to be allocated in accordance with an example embodiment.

FIG. 3B is a diagram illustrating a user interface displaying allocation results in accordance with an example embodiment.

FIGS. 4A-4C are diagrams illustrating graphs of demand versus capacity in different allocation scenarios in accordance with example embodiments.

FIG. 5 is a diagram illustrating a method of determining partial quantities of an object to be allocated in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

A store (e.g., a market, a merchant, an entity, etc.) may have a predetermined storage area (physical space) set aside for a particular type of good such as chilled goods, frozen goods, dry storage, alcoholic beverages, and the like. One example is a predetermined area set aside for selling promotional goods (referred to as spot areas) which are sold for a limited time. Not all stores have the same capacity (space for storing the product), the same demand, or the same promotions. Therefore, determining which store receives which quantity of an item can be challenging. In some cases, a store may receive too much of an item while another store may not receive enough. Balancing the demand and the available storage capacities of different stores can be difficult for a product distributor/supplier that must allocate products to competing stores. Related systems typically focus on demand with a static maximum stock setting as an upper limit for a specific store. However, this fails to consider the fill level across the stores. Therefore, some stores will be overflowed with a product, while others do not have enough. Furthermore, the problem can be insoluble for a human given the vast number of allocation combinations across hundreds or thousands of stores, and the impossibility of checking the implications of such decisions across all stores. In this case, the complexity of the optimization problem to be solved (i.e., the number of combinations to check) grows exponentially for each product and/or each store. Thus, even an example with a few stores and a few products cannot be processed by a human in a reasonable amount of time.

The example embodiments provide a software system that can optimize the fill levels for the same store areas across multiple stores and multiple products, the predicted demand per product across the stores, the range of coverage per product across the stores, and the predicted demand fulfillment per product across the stores. The optimization can result in an allocation of the item such that each store has a similar fill level of the available shelf/storage capacity of the store. However, the quantities of the individual items that contribute to these fill levels may be very different, because the demands may be different. The range of coverage for one individual product across all stores will be similar. For example, store A and store B may have the same volume of store area for a product, but store A may have a demand of 150 units of the product per day while store B has a predicted demand of 75 units of the product per day. In this case, if each store were to receive an extra 300 units, it would take store A only two days to sell such extra units, while it would take store B four days. Therefore, range of coverage is also considered as part of the balancing equation. Every item in a spot area consumes available capacity of a store. When the item is sold, it frees capacity for the store. The system described herein attempts to free capacity as soon as possible such that capacity is free for new items or new promotions in the same spot area. Therefore, the system attempts to assign products in such a way that the products sit on the shelf (or in a bin) for the least amount of time.

The system may output a user interface which allows users to define the available storage capacity for various types of goods. The user interface may also allow the user to specify how much capacity is available for particular types of items (e.g., cereal, chips, pasta sauce, olive oil, wine bottles, canned soup, etc.) The system may model each of the available storage capacities in a common manner across all stores that allows for the system to comparatively understand how much space is available at each location.

In some embodiments, the system may predict (forecast) the upcoming demand of a store over a future period of time (e.g., next week, next month, next three months, etc.). For example, a machine learning algorithm trained from historical demand values for a given item (or for all items) may determine an estimated amount of an item that will be required over a future period of time. The machine learning algorithm may receive inputs such as current inventory, historical demand, open orders, and the like, for an item, and predict how much demand there will be over a future period of time.

When the system receives a quantity of an item to be allocated, the system may optimally determine how much partial quantity of the item to allocate to each store based on the predicted demand and the available capacity per store area for all stores. It should also be appreciated that the system may perform such allocation for multiple items at the same time (i.e., simultaneously) across all stores. This scenario is significantly more complex than the one item allocation scenario. However, for convenience of description, the examples herein refer to one item being allocated to a group of stores.

According to various embodiments, a linear programming model may simultaneously determine an optimal amount of the item to allocate to a plurality of stores based on available storage capacity and the predicted demand across all of the stores. Therefore, the look of the fill level across all products in the store area may be comparatively the same across all stores, even those with different storage capacities. In addition to fill level, the linear programming model may also account for expected demand and provide an optimal allocation quantity based on a balance between both the available storage capacity, the demand and the range of coverage for each item across the stores. In some embodiments, the system may also enable users to specify preferences in allocation. For example, the user may set a higher weight for demand over fill level, or vice versa. Thus, the users may personalize the allocation of the product for their particular interests.

The example embodiments may automatically optimize the fill level of store areas with items from a central distributor based on forecasted demands and free capacity within the stores. Two competing business objects (e.g., demand fulfillment and balanced fill levels between stores) may be achieved through the use of linear programming. The linear programming model may use an optimization function that is based on an optimization function library (OFL) that is further described herein. Some of the benefits of the system described herein include fulfilling offer demand while balancing fill levels (over fulfillment, under fulfillment, etc.) across all stores in a competing environment. In some embodiments, the system may also balance other attributes such as range of coverage (days) that the product is available at each store, and the like.

In the example, the store (e.g., merchant, user, etc.) is often associated with a grocery store such as a market, wine shop, liquor store, discount store, and the like, and the items (also referred to as objects) are associated with food related products. However, it should also be appreciated that the example embodiments may be applied to any type of item such as an appliance, an automobile, a device, clothing, shoes, or the like. Likewise, the store may be any kind of store such as an appliance store, an electronics store, an automobile dealership, a clothing store, a shoe store, and the like. Thus, the embodiments described herein should not be construed as being limited to a particular item or a particular type of store (or merchant). Furthermore, while the examples may refer to distribution of one item (or object) being performed, it should be appreciated that the system herein can simultaneously determine an optimal distribution of multiple items across multiple stores.

Accordingly, the example embodiments provide a system which can model the capacity of store areas in stores, measure free capacity per store rea and store at a date of next delivery, and optimize the use of the free capacity per store area and store. The modelling of capacity may consider multiple store areas (e.g., grocery, non-food, beverage, etc.) assigned to a market unit (a store format in a country, for example) and one or more product groups assigned to the store areas. Store area templates may include capacity and logistical rules and may be assigned to the stores for mass maintenance. Some stores may have individual exceptions to the templates. The free capacity may be measured based on earlier promotional offerings, real-time stock/inventory, and predicted forecast of future stock needed. Furthermore, the optimization may be performed based on multiple competing targets including predicted demand, balanced fill level across all stores, and range of coverage.

Before optimization can start, various information may be determined as a starting point for the stores including store area capacity in cubic volume, fill limit in cubic volume, and initial volume consumed by existing products. The initial volume is the inventory and open orders projected from the current date to the store delivery date plus the minimum order quantity.

The capacity, fill limit, and initial volume per store plus the additional information is passed to an optimization function library (OFL) of the system using a linear programming solver described herein. Some of the additional information passed to the OFL may include total allocation quantity for a DC, to be allocated across the eligible stores, the issue unit of measure conversion (for example, number of pieces that fit in a carton), the number of pieces in one unit of the issue (logistic conversion rate), the product volumes in cubic meters (either determined from product dimensions or from settings), the product priority (derived for each tactic category, equidistant between weights of the smallest and largest priority of the tactic category), the projected, initial store inventory in sales units, the offer demand in sales units, the average offer forecast in sales units per day, required to calculate the range of coverage, and the like.

The linear programming model may optimize allocation of quantities per product and store in such a way that the following occurs.
a) The demand of each product is fulfilled and converted into the unit of issue (e.g. cartons, quarter pallets, pallets).
b) The demand fulfillment is more important for higher prioritized products (depending on the tactic category for that product in the respective offer).
c) The over-fulfillment and under-fulfillment of stores is balanced.
d) The range of coverage for each product is balanced across all stores (deviations kept as low as possible).

The stores have a balanced fill level (percentage of normal capacity) across all products of a particular store area (deviations kept as low as possible) and the store areas cannot exceed the fill limit. Furthermore, additional constraints may apply. For example, constraints may include a total allocation quantity (which is availability minus a selected putaway quantity, if applicable). This might not be possible if all stores are over their fill limit. Other constraints may include store areas cannot exceed the fill limit. Furthermore, the output of the linear programming model may include an allocation quantity per product or product variant in unit of issue, a putaway quantity in unit of issue, an expected fill level after allocation (per store), and the like.

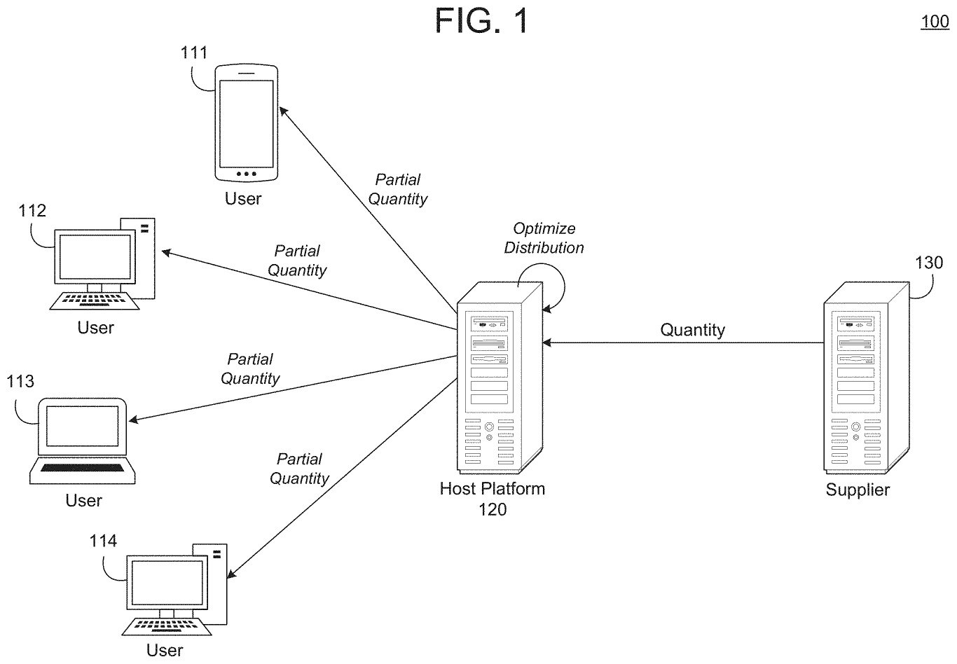

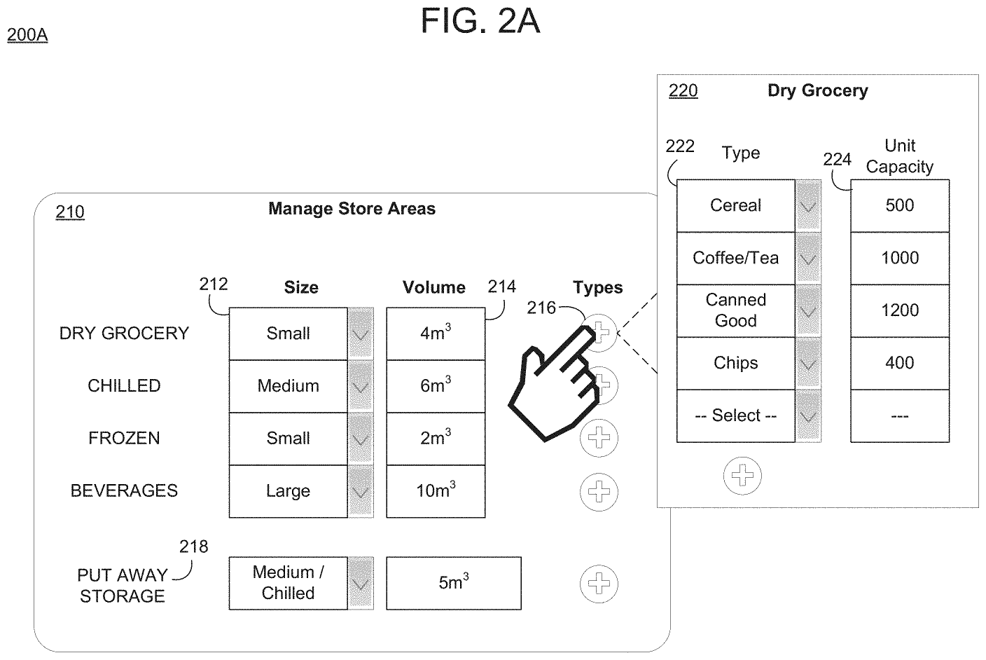

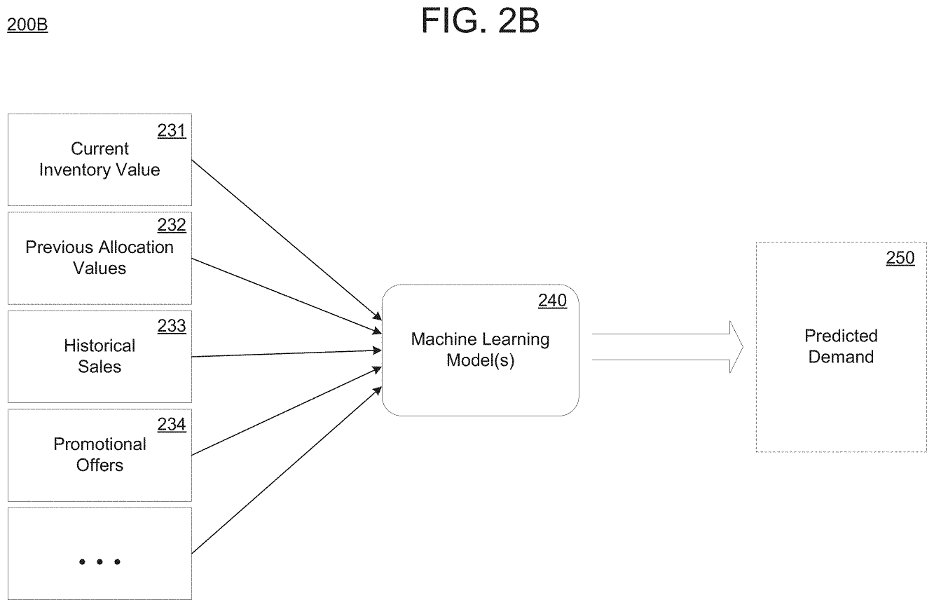

FIG. 1 illustrates a computing environment 100 capable of determining a quantity to allocate in accordance with an example embodiment. Referring to FIG. 1, a supplier 130 has a quantity of an item to distribute to a plurality of users (e.g., stores, warehouses, locations, etc.) In this example, a host platform 120 may determine an optimal amount of partial quantity to allocate to each of the users among the plurality of users 111-114 based on expected demand and balanced fill levels among the users 111-114. As further described below with respect to FIGS. 2A and 2B, the plurality of users 111-114 may each define available sales areas within their stores capable of storing product. Here, the available areas may be areas within the store that are viewable by customers. Also, the plurality of users 111-114 may provide additional storage information such as storage space that is not viewable to the customers, such as a back storage area, a warehouse, a storage container, a closet, or the like.

Each of the plurality of users 111-114 may access the host platform 120 via a network such as the Internet. Here, the plurality of users 111-114 may be computing devices such as desktop computers, laptops, mobile phones, tablets, etc., which can be used to login to an account, etc., of an application hosted by the host platform 120. The host platform 120 may be a web server, a cloud platform, a database, and the like. The tool described herein may be implemented within the host platform 120 and available to the users 111-114 via a user interface, a URL, a mobile application, or the like.

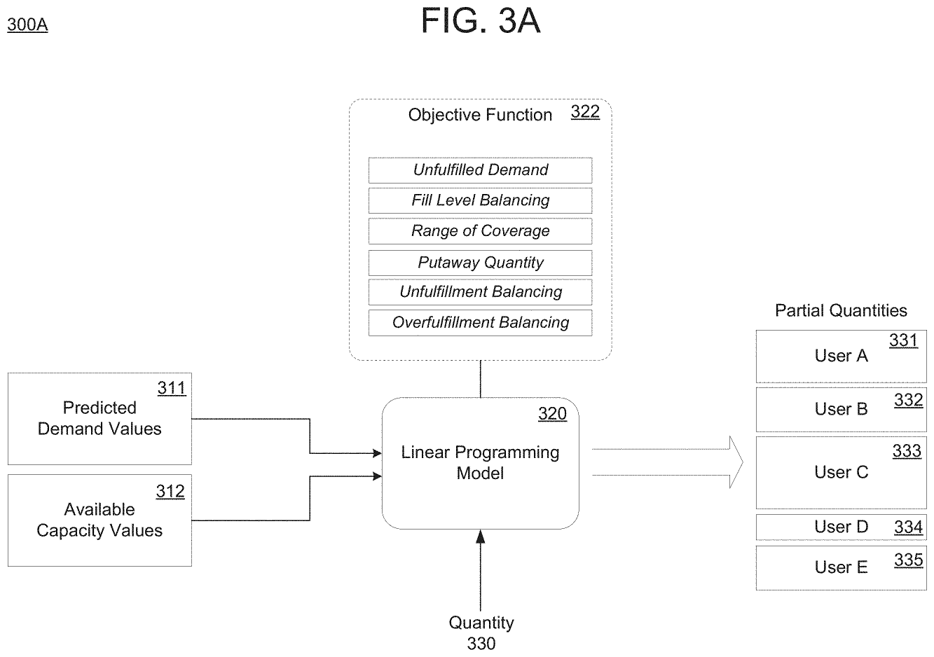

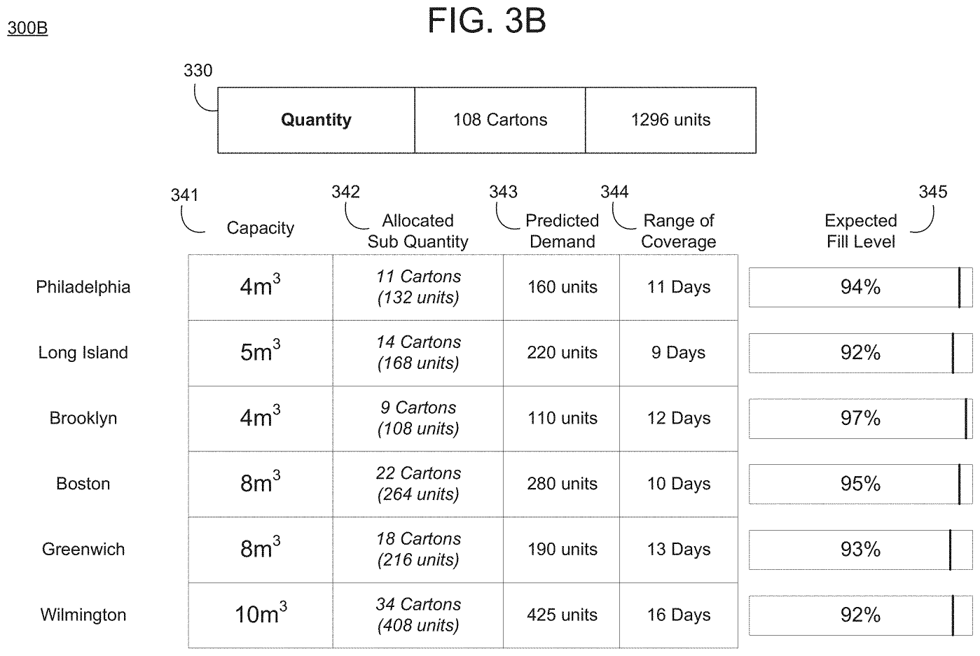

When the supplier 130 provides a quantity of an item to be allocated, the host platform 120 may determine an optimal amount (partial quantity) of the item that is to be allocated to each of the plurality of users 111-114. Here, the host platform 120 may execute a linear programming model which includes an optimization function that considers expected demand of each of the users 111-114 and available fill areas of the users 111-114. The optimization function may consider other factors as well, as further described below with respect to FIG. 3A. The partial quantities that are determined may differ for each of the users 111-114 based on different demands, available fill levels (of customer space), and the like. The host platform 120 may display the resulting partial quantity values on a screen, send the partial quantity values to the supplier 130, and the like.

The example embodiments may be used with promotion-driven products such as spot items, although embodiments are not limited thereto. In a spot display, items are offered for sale at a discount and for a limited time only. These items can go fast or the items may take a while. Keeping the front display of the items similar across all stores may provide customers with a common view/experience when shopping. For example, a display for an item of cereal at a store near home may look similar to a display for the item of cereal at a store near work.

The system may use machine learning to generate a demand forecast which includes a prediction of store demands. Furthermore, the system may use data intelligence (e.g., linear programming, etc.) to balance fill levels across all stores in consideration of demand. In some embodiments, the optimization may consider other factors such as current inventory, current promotions, store schedules, logistic rules, demand, availability capacity, priority of an item, unfulfillment of an item, and the like. This data may be real-time data thereby providing accurate optimization. For example, if spot products are announced in a weekly flyer, the spot products need to be sent to all stores. Meanwhile, non-advertised products may only be sent to stores if there is sufficient space (or they are lower in amount, etc.). Furthermore, unfulfillment of an announced product can be worse than for an unannounced product. Therefore, the demand of the announced products may have higher priority.

FIG. 2A illustrates a user interface 200A for modeling available capacity in accordance with an example embodiment. Referring to FIG. 2A, the user interface 200A includes a window 210 for managing available storage areas. For example, the user interface 200A may be output by the host platform 120 shown in FIG. 1, on a user device of any of the plurality of users 111-114. In this example, a user can define a size of storage area for different types of items. Here, the items are grocery-related items. The storage areas may include upfront/sales areas where items can be placed and shown for sale including dry grocery, chilled (refrigerators), frozen (freezers), beverages, and the like. In addition to the upfront sales space, the window 210 may also provide an option 218 for managing hidden/backroom storage space, which is referred to herein as putaway storage.

The user may select a drop-down menu and generate an input for a size field 212 which may broadly describe the storage area as small, medium, large, extra-large, or the like. As another option, the user may select a volume field 214 which allows the user to specify a measured size of the storage area. However, it should be appreciated that size 212 and volume 214 are just examples, and other selections may be made possible such as carton count, unit count, palette count, and the like. In some embodiments, the window 210 may also provide a type button 216 which the user can select causing a sub-window 220 to be displayed which allows the user to specify specific amounts for various types of items in a particular category. In this example, the window 220 include a type field 222 for selecting specific product types from a predefined list/menu and a unit capacity field 224 which allows the user to specify a specific number of units that the store can hold for each particular type of item.

Although not shown in FIG. 2A, the user interface 200A may include other selectable options available to users. For example, the system may provide templates that describe store area capacity, logistics rules that specify if stores may not receive certain logistic units, such as pallets, and if there is a minimum quantity that has to be sent in any case. The templates may also include visual markers of past, current or future fill levels, and the like. Those fill levels may be calculated automatically based on past allocations, current inventory and open orders, as well as projected sales. Also, the user interface 200A may be used by a backend user of the system to view multiple different stores at once such as shown in FIG. 3B. The backend user may also create rules and apply changes to storage capacity, demand, and the like, of a store.

Each store can define its own market area of available space. For example, one store may provide an available capacity of 10 m³ for dry storage, while another store may provide an available capacity of 5 m³ for dry storage. For example, the capacity of a store area may be measured in available volume. A user may assign product groups to store areas and indicate how the system should measure the volume of a product in each store area as a conversion factor or through explicit calculation of length, width, height, etc. of a product. How the available volume for each store and each store area is determined may be uniform throughout all stores. A store has a capacity for a store area (e.g., 5 m³ for chilled goods). However, how much of this volume is available (e.g., 2 m³, etc.) may be anticipated by the system using current inventory minus predicted forecast, plus planned good receipts. As another example, if all items in a product group assigned to a spot area have the same dimensions (consumption of capacity), the capacity could be measured in pieces or amount of a particular item (e.g., bottles of wine, cans of soda, etc.).

FIG. 2B illustrates a process 200B of predicting demand in accordance with an example embodiment. The processor 200B may be performed for each user and for each item from among multiple different items. For example, a machine learning algorithm 240 may be trained based on past sales, prices, events, weekdays, etc. in order to model sales behavior and forecast future demand. The machine learning algorithm 240 may receive a current inventory value 231 for an item, one or more previous allocation values 232 of the item, historical sales of the item 233, promotional offers at the store 234, and the like, as inputs, and predict a demand 250 of the store for a future period of time such as a next week, a next month, a next three months, a next six months, and the like. The demand may be predicted for each store. Also, the demand may be predicted for each item among a plurality of different items. The predicted demand 250 may be used by a linear programming model when generating an optimal sub quantity of an item to be allocated to a store.

FIG. 3A illustrates a process 300A of a linear programming model determining sub quantities of an item in accordance with an example embodiment, and FIG. 3B illustrates a user interface 300B displaying allocation results to a plurality of stores in accordance with an example embodiment. Referring to FIG. 3A, a linear programming model 320 can optimize an available quantity 330 (also shown in FIG. 3B) for break-up and distribution among a plurality of users 331-335. Here, the plurality of users 331-335 represent a plurality of stores, respectively. Each user is allocated a partial quantity of the quantity 330.

The linear programming model 320 receives the predicted demand values 311 of the plurality of users 331-335 and the available capacity values 312 of the plurality of users 331-335 as inputs. Furthermore, an objective function 322 of the linear programming model 320 may optimize the partial quantities that are to be distributed to the plurality of users 331-335 based on various attributes. The objective of the linear programming model 320 is to push the quantity 330 (often the total available quantity) of items/products to stores. In doing this, the linear program model 330 may use the predicted demand values 311 and the available capacity values 321 of the plurality of users 331-335.

The determination by the linear programming model 320 may take into account expected fill levels for store areas on the store delivery date, the fill limits, the product volumes, product priority, and the demand forecast for a product or products in order to achieve various objectives. For example, the objectives may include fulfilling offer demand and balance over-fulfillment and under fulfillment across the stores. The objectives may further include balancing the fill levels of the corresponding store areas of the stores, and balancing a range of coverage of the products across the stores.

In some embodiments, the linear programming model 320 may include conditions, but is not limited thereto. Examples of some of the conditions include converting the quantity into logistical units of measure (e.g., carton, unit, etc.), the fill limits may not exceed a certain threshold (e.g., 100%, 120%, 150%, etc.), the total allocation of the quantity must be performed unless all stores exceed their limit, and the like. Also, in some embodiments, different products may have different priorities. A user can choose to weight priorities/factors considered by the objective function based on their own interests. The objective function 322 may include the following decision variables:

Unfulfilled demand by product, multiplied by product priority

Fill level balancing across all stores

Putaway quantity

Range of coverage balancing

Overfulfillment balancing

Unfulfillment balancing

Highest ranked product

Lowest ranked product

It should be appreciated that these decision variables are just examples. The decision variables may include recommended weighting factors. For example, a user can influence the results of the optimization process by the linear programming model 320 by changing the weights applied to any of the decision variables. For example, the decision variables may have default weights that can be dynamically adjusted by users. In some cases, different users may have different weights applied to the same decision variable.

In these examples, the unfulfilled demand represents the demand of all stores across all products that could not be fulfilled by the allocation. The lower the value, the more demand is fulfilled. The fill level balancing represents how similar the fill levels of the individual stores will be after allocation. The lower the value, the smaller the gap between the least and most filled store. The putaway quantity represents the quantities that could not be allocated to stores for capacity constraints extra storage. The lower the value is, the more complete was the total allocation quantity consumed. The range of coverage balancing represents how similar the expected range of coverage of an individual product in the different stores will be after. allocation. The lower the value, the closer the values of the lowest and the highest RoC values are across all stores.

As another example, unfulfillment balancing represents how similar the unfulfillment will be between stores and products. The smaller the value, the closer the lowest and highest unfulfillment rates of the stores are across all products. Overfulfillment balancing represents how similar the overfulfillment will be between stores and products. The smaller the value, the closer the lowest and highest overfulfillment rates of the stores are across all products. Product ranking is an additional weighting factor for the unfulfillment demand decision variable used to consider the fulfillment of more highly prioritized products as more important than the fulfillment of products with a lower prioritization. In some embodiments, the highest ranked product and the lowest ranked product may include respective multiplication factors. For example, the multiplication factor of the highest ranked product may be multiplied with unfulfilled demand so that the demand fulfillment of high prioritized products gives more benefit than the demand fulfillment of lower prior products.

In some embodiments, past allocations may be used by the system to determine free capacity. For example, the system may identify what products were allocated in which store in the last x weeks (the number can be configured) into which store area. Here, the system can check current stock and project future stock in the store area (by store), and then calculate the capacity in meter cube that those products will consume. From that, the system may also calculate the available capacity. Then the linear programming algorithm may perform the balancing of demand, fill level and range of coverage as described.

FIG. 3B illustrates a user interface 300B displaying an outcome of the linear programming model 320 shown in FIG. 3A. In this example, the quantity 330 includes a total of 108 cartons which corresponds to 1296 units. Here, the units may refer to any type of product such as an item of food, a consumer electronic, an appliance, an item of clothing, a pair of shoes, an automobile, and the like. In this example, the user interface 300A includes six different stores which receive a partial quantity of the item. The user interface shows current available capacity 341, a partial quantity value 342 allocated to the respective store, a predicted demand value 343 measured in units, a range of coverage value 344, and the like. The predicted demand value 343 is based on the demand over a 10 day period. Furthermore, an expected fill level 345 graph 345 is shown for each store. The output shown in FIG. 3B is just for purposes of example. It should be appreciated that different values, additional values, different formats, or the like, may be used to provide the outcome to the viewer.

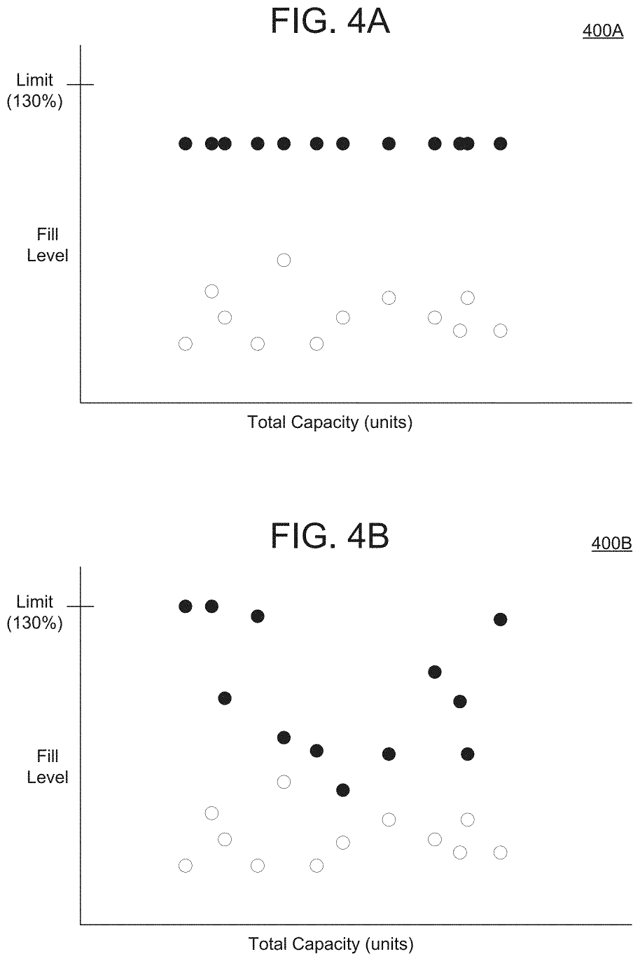

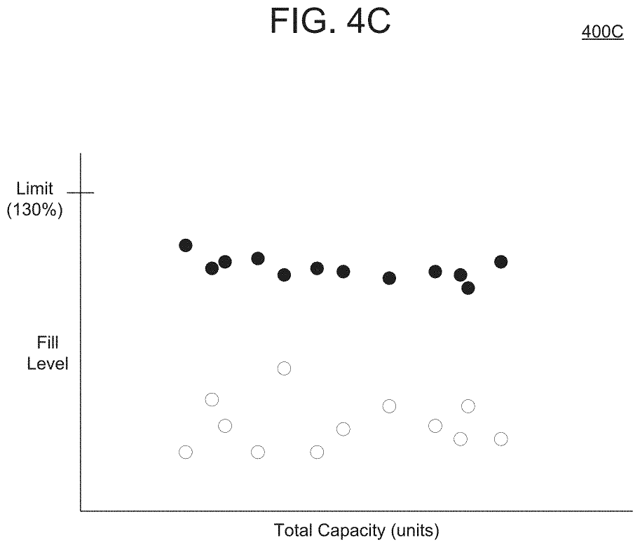

FIGS. 4A-4C illustrate graphs of demand versus capacity in different allocation scenarios in accordance with example embodiments. Referring to FIG. 4A, a graph 400A includes a result of allocating partial quantities to different stores with a strong weight applied towards fill level balancing among the stores and little weight applied to forecasted demand. The x axis of the graph represents a stores total capacity and the y axis of the graph represents a stores fill level measured in percentage. In this example, each store includes an empty dot and a block dot directly above. Here, the empty dot represents a stores inventory/quantity prior to the allocation and the black/filled-in dot represents the store's inventory/quantity after the allocation. As a result of the allocation, the filled-in dots representing the fill level after the allocation are about the same for all stores.

FIG. 4B illustrates a graph 400B that includes a result of allocating quantity to different stores with a strong weight applied towards demand and very little weight applied towards fill level balancing. In this example, each store again includes an empty dot and a filled-in dot directly above. Because the forecasted demand is given the stronger weight, some stores receive over their capacity resulting in an overfulfilled fill level and some receive stores receive less than their capacity resulting in an underfulfilled fill level.

Meanwhile, FIG. 4C illustrates a graph 400C in which both forecasted demand and balanced fill level across all stores are both weighted similarly. In this case, the empty dot represents the initial fill level of the store, and the black/filled-in dot represents the fill level of the store after allocation of a partial quantity. Here, each store receives an amount that considers both the demand of the store with respect to the other stores, and the fill level of the store and the fill levels of the other stores. Thus, the linear programming model may simultaneously optimize a partial quantity to be allocated to each of the plurality of stores based on respective demands and fill levels of all stores considered at the same time.

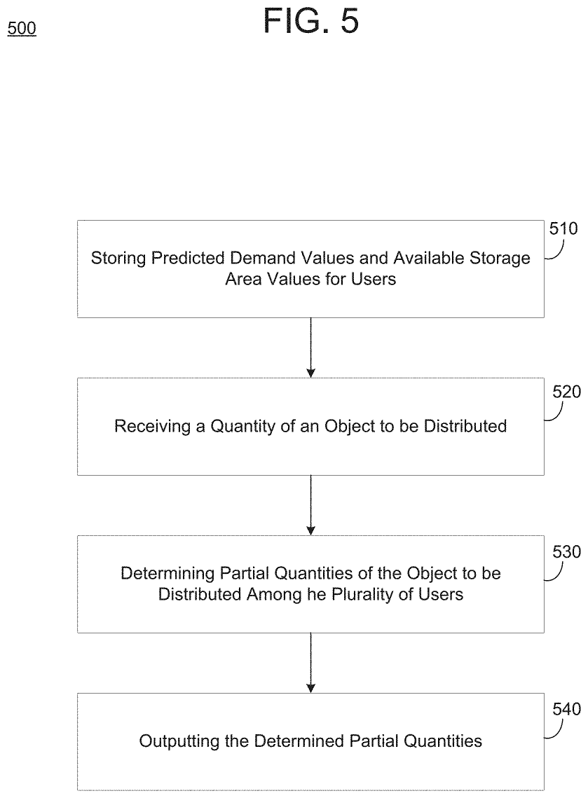

FIG. 5 illustrates a method 500 of determining partial quantities to be allocated in accordance with an example embodiment. For example, the method 500 may be performed by a software program such as an application, a service, or other program that is executing on a database node, a cloud platform, a server, a computing system (user device), a combination of devices/nodes, or the like. Referring to FIG. 5, in 510, the method may include storing predicted demand values for an object and available storage area values for the object from a plurality of users, respectively. For example, the predicted demand values may be predicted from one or more machine learning algorithms. The predicted demand may include an estimate of how much of an item will be sold/purchased over a predetermined period of time in the future such as a week, a month, six months, or the like. In some embodiments, the method may further include predicting the demand value for a user via a machine learning model based on a current fill level, open orders, previous quantities of the object allocated to the user, and the like.

In some embodiments, the method may further include receiving inputs describing storage areas for the object from the plurality of users, and determining the available storage area values for the object of the plurality of users based on the inputs describing the storage areas. For example, the system may model the available storage area of each store in such a way that it is compatible/comparable across all stores. For example, one user may provide a description of a size (e.g., small, medium, large, etc.) of a particular storage area (e.g., dry goods, chilled goods, freezer, beverages, etc.) and another user may provide a specific unit amount of a particular product. The system may model each of these inputs into a common format such as unit size or storage size, etc.

In 520, the method may include receiving a quantity of the object to be distributed among the plurality of users. For example, the quantity may represent a quantity of a product that is to be distributed from a central distributor/system to a plurality of stores/users. The quantity may be represented as individual units (bottles, boxes, containers, cans, etc.). As another example, the quantity may be represented as bulk such as a carton, a palette, or the like.

In 530, the method may include simultaneously determining partial quantities of the object to be distributed among the plurality of users based on the predictive demand values for the object and available storage area values for the object among the plurality of users. Furthermore, in 540 the method may include outputting the determined partial quantities of the object for display.

According to various embodiments, the simultaneously determining may include executing a linear programming model which respectively optimizes the partial quantities of the object to be distributed to the plurality of user based on the predicted demand values for the object and the available storage area values for the object. In some embodiments, the linear programming model may include an objective function that is based on one or more of excess storage capacity, fill level balancing, overfulfill balancing, and unfulfilled balancing. It should also be appreciated that other factors may be considered by the linear programming model, and should not be limited to the examples used herein.

In some embodiments, the simultaneously determining may include determining a partial quantity for a user based on weights provided by the user, which are to be applied to a predicted demand value for the object of the user and an available storage area value for the object of the user. In some embodiments, the simultaneously determining may further include determining the partial quantities of the object to be distributed among the plurality of users based on overfulfill capacity values of the plurality of users. In some embodiments, the simultaneously determining may include determining the partial quantities of the object to be distributed among the plurality of users based on unfulfilled balancing among the plurality of users.

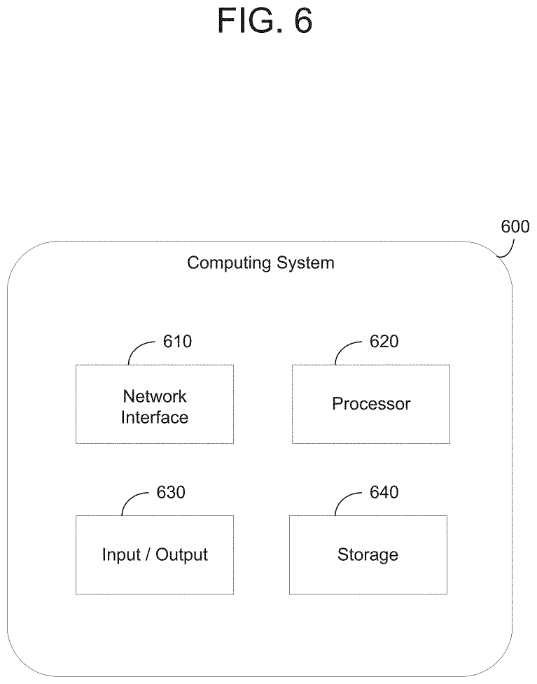

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the method shown in FIG. 5. According to various embodiments, the storage 640 may include a data store having a plurality of tables, partitions and sub-partitions. The storage 640 may be used to store database records, items, entries, and the like. In some embodiments, the storage 640 may be configured to store instructions for managing a configuration repository for a distributed system.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store predicted demand values for an object and available storage area values for the object from a plurality of users, respectively; and
a processor configured to
receive a quantity of the object to be distributed among the plurality of users,
determine partial quantities of the object to be distributed among the plurality of users based on the predictive demand values for the object and available storage area values for the object among the plurality of users, and
output the determined partial quantities of the object for display.

2. The computing system of claim 1, wherein the processor is configured to execute a linear programming model which respectively optimizes the partial quantities of the object to be distributed to the plurality of user based on the predicted demand values for the object and the available storage area values for the object.

3. The computing system of claim 2, wherein the linear programming model comprises an objective function that is based on one or more of excess storage capacity, fill level balancing, overfulfill balancing, and unfulfilled balancing.

4. The computing system of claim 1, wherein the processor is configured to determine a partial quantity for a user based on weights provided by the user, which are to be applied to a predicted demand value for the object of the user and an available storage area value for the object of the user.

5. The computing system of claim 1, wherein the processor is further configured to predict the demand value for a user via a machine learning model based on a current fill level, open orders, and previous quantities of the object allocated to the user.

6. The computing system of claim 1, wherein the processor is further configured to receive inputs describing storage areas for the object from the plurality of users, and determine the available storage area values for the object of the plurality of users based on the inputs describing the storage areas.

7. The computing system of claim 6, wherein the inputs comprise sizes representing capacities of the storage areas.

8. The computing system of claim 1, wherein the processor is further configured to determine the partial quantities of the object to be distributed among the plurality of users based on overfulfill capacity values of the plurality of users.

9. The computing system of claim 1, wherein the processor is further configured to determine the partial quantities of the object to be distributed among the plurality of users based on unfulfilled balancing among the plurality of users.

10. A method comprising:
storing predicted demand values for an object and available storage area values for the object from a plurality of users, respectively;
receiving a quantity of the object to be distributed among the plurality of users;
determining partial quantities of the object to be distributed among the plurality of users based on the predictive demand values for the object and available storage area values for the object among the plurality of users; and
outputting the determined partial quantities of the object for display.

11. The method of claim 10, wherein the determining comprises executing a linear programming model which respectively optimizes the partial quantities of the object to be distributed to the plurality of user based on the predicted demand values for the object and the available storage area values for the object.

12. The method of claim 11, wherein the linear programming model comprises an objective function that is based on one or more of excess storage capacity, fill level balancing, overfulfill balancing, and unfulfilled balancing.

13. The method of claim 10, wherein the determining comprises determining a partial quantity for a user based on weights provided by the user, which are to be applied to a predicted demand value for the object of the user and an available storage area value for the object of the user.

14. The method of claim 10, further comprising predicting the demand value for a user via a machine learning model based on a current fill level, open orders, and previous quantities of the object allocated to the user.

15. The method of claim 10, further comprising receiving inputs describing storage areas for the object from the plurality of users, and determining the available storage area values for the object of the plurality of users based on the inputs describing the storage areas.

16. The method of claim 15, wherein the inputs comprise sizes representing capacities of the storage areas.

17. The method of claim 9, wherein the determining further comprises determining the partial quantities of the object to be distributed among the plurality of users based on overfulfill capacity values of the plurality of users.

18. The method of claim 9, wherein the determining further comprises determining the partial quantities of the object to be distributed among the plurality of users based on unfulfilled balancing among the plurality of users.

19. A non-transitory computer-readable medium storing instructions which when executed by a processor cause a computer to perform a method comprising:
storing predicted demand values for an object and available storage area values for the object from a plurality of users, respectively;
receiving a quantity of the object to be distributed among the plurality of users;
determining partial quantities of the object to be distributed among the plurality of users based on the predictive demand values for the object and available storage area values for the object among the plurality of users; and
outputting the determined partial quantities of the object for display.

20. The non-transitory computer-readable medium of claim 19, wherein the determining comprises executing a linear programming model which respectively optimizes the partial quantities of the object to be distributed to the plurality of user based on the predicted demand values for the object and the available storage area values for the object.
